(19) United States
(12) Patent Application Publication
(10) Pub. No.: US 2020/0033664 A1
(43) Pub. Date: Jan. 30, 2020

(54) VEHICLE DISPLAY DEVICE

(71) Applicant: KABUSHIKI KAISHA TOKAI-RIKA-DENKI-SEISAKUSHO, Aichi (JP)

(72) Inventor: Keishi KANEMATSU, Aichi (JP)

(21) Appl. No.: 16/086,169

(22) PCT Filed: Mar. 22, 2017
(86) PCT No.: PCT/JP2017/011514

§ 371 Date: Sep. 18, 2018

(30) Foreign Application Priority Data
Mar. 28, 2016 (JP) 2016-063933

(51) Int. Cl. G02F 1/1333; B60R 16/03; H05B 1/02

(52) U.S. Cl. CPC G02F 1/133382; B60R 11/0229; H05B 1/0236; B60R 16/03

(57) ABSTRACT

A vehicle display device includes a liquid crystal display unit, a temperature sensor that detects a temperature of the liquid crystal display unit, another ECU that acquires vehicle information including a detection result of an external temperature sensor, a heater that heats the liquid crystal display unit, and a microcontroller. The microcontroller controls a heater drive circuit such that the heater is driven at a predetermined first electric power level in cases in which an external temperature at or below 0° C. has been detected by an external temperature sensor and a smart key has been detected by a smart key detector, and such that the heater is driven at a second electric power level greater than the first electric power level in cases in which a door has been opened or a door lock has been unlocked and a temperature at or below 5° C. has been detected by the temperature sensor.

### TECHNICAL FIELD

The present invention relates to a vehicle display device that is mounted to a vehicle and that displays various information, images, and the like.

### BACKGROUND ART

Cold cathode fluorescent tubes employed in meter lighting devices, liquid crystal display devices, or the like in an automobile experience a drop in brightness at low temperatures, and so a heater is provided to heat the tubes to compensate for the drop in brightness at low temperatures.

For example, Japanese Patent Application Laid-Open (JP-A) No. H09-48281 proposes activating a heater to preheat a cold cathode fluorescent tube when unlocking of a door lock of the automobile has been detected, thereby ensuring that automobile lighting equipment that drops in brightness at low temperatures is sufficiently bright at low temperatures.

### SUMMARY OF INVENTION

### Technical Problem

However, a drop in performance at low temperatures is not limited to cold cathode fluorescent tubes. For example, there is an issue with liquid crystals employed in liquid crystal display devices in which the response speed of the liquid crystals drops at low temperatures, such the display is delayed. A conceivable response thereto is to compensate for the delay in the response of the liquid crystals by heating the liquid crystals with a heater similarly to in JP-A No. H09-48281.

However in JP-A No. H09-48281, activating the heater when the door lock has been unlocked results in a large amount of electric power being consumed by the heater, and so there is room for improvement with respect to saving electric power.

In consideration of the above circumstances, an object of the present invention is to mitigate a drop in the response speed of a liquid crystal display device at low temperatures before a vehicle starts running, while saving electric power.

### Solution to Problem

In order to achieve the above object, a first aspect of the present disclosure includes a display section that displays an image, an acquisition section that acquires information indicating at least one temperature out of a temperature of the display section or an external temperature, a heater that heats the display section, and a controller that controls driving of the heater. The heater is thereby driven at a predetermined first electric power level in cases in which information indicating a temperature at or below a predetermined temperature at which there is a possibility of a drop in a response speed of the display section is acquired by the acquisition section, and in which a predetermined preheating condition of the heater is satisfied, and such that the heater is driven at a second electric power level greater than the first electric power level in cases in which a predetermined drive condition of the heater is satisfied.

In the first aspect of the present disclosure, the display section displays an image. The display section displays images using, for example, liquid crystals.

Information indicating at least one temperature out of the temperature of the display section or the external temperature is acquired by the acquisition section, enabling determination to be made, based on the acquired information indicating temperature, as to whether this is a temperature at which the responsiveness of the display section drops.

The display section is heated by the heater. Thus, for example, at low temperatures at which the response speed of the display section drops, the display section is able to be heated by the heater to mitigate the drop in the response speed.

The controller that controls driving of the heater such that the heater is driven at the predetermined first electric power level in cases in which information indicating a temperature at or below a predetermined temperature at which there is a possibility of a drop in the response speed of the display section is acquired by the acquisition section, and in which the predetermined preheating condition of the heater is satisfied, and such that the heater is driven at the second electric power level greater than the first electric power level in cases in which the predetermined drive condition of the heater is satisfied. Thus driving the heater using two levels of electric power, enables electric power to be saved compared to cases in which the heater is driven at a single electric power level. This enables a drop in the response speed of the display section at low temperatures before the vehicle starts running to be mitigated, while saving electric power.

Note that, as in a second aspect of the present disclosure, the preheating condition may be a condition that is satisfied in cases in which a smart key has been detected by a detection section for detecting the smart key. This enables the heater to be driven prior to an operator boarding.

Further note that, as in a third aspect of the present disclosure, the drive condition may be satisfied in cases in which information indicating a temperature at or below the predetermined temperature is acquired by the acquisition section, and boarding of an operator is detected by a boarding detection section for detecting operator boarding. This enables the heater to be driven at the second electric power level to promote heating of the display section at boarding, at which point there is a higher possibility of the display section being used than when the preheating condition is satisfied.

Moreover, as in a fourth aspect of the present disclosure, the controller may further control driving of the heater such that electric power supplied to the heater to drive the heater is switched to a third electric power level greater than the second electric power level in cases in which an automobile ignition switch has been switched on while the heater is being driven. It is thereby possible to drive the heater at the third electric power level, enabling a further saving in electric power.

Moreover, as in a fifth aspect of the present disclosure, the acquisition section may acquire a detection result from an external temperature detection section that continually detects the external temperature as the information indicating the external temperature. Namely, acquiring the detection result from the external temperature detection section that continually detects the external temperature enables the temperature to be detected without activating a temperature sensor or the like provided to the display section, enabling a saving in electric power.

Moreover, as in a sixth aspect of the present disclosure, the controller may further control driving of the heater such that driving of the heater is stopped in cases in which the preheating condition is no longer satisfied when the heater is being driven at the first electric power level. Wasteful consumption of electric power is thereby prevented, enabling a further saving in electric power.

Moreover, as in a seventh aspect of the present disclosure, the controller may further control driving of the heater such that driving of the heater is stopped in cases in which a temperature higher than the predetermined temperature has been acquired by the acquisition section when the heater is being driven at the first electric power level. This also prevents wasteful consumption of electric power, enabling a further saving in electric power.

### Advantageous Effects of Invention

As explained above, the present invention has the excellent advantageous effect of enabling a drop in the response speed of a liquid crystal display device at low temperatures before a vehicle starts running to be mitigated, while saving electric power.

### BRIEF DESCRIPTION OF DRAWINGS

FIG. 1 is a block diagram schematically illustrating a configuration of a vehicle display device according to an exemplary embodiment.

FIG. 2 is a flowchart illustrating an example of a flow of processing implemented by a microcontroller of a vehicle display device according to the exemplary embodiment.

FIG. 3 is a flowchart illustrating a first modified example of a flow of processing implemented by a microcontroller of a vehicle display device according to the exemplary embodiment.

FIG. 4 is a flowchart illustrating a second modified example of a flow of processing implemented by a microcontroller of a vehicle display device according to the exemplary embodiment.

### DESCRIPTION OF EMBODIMENTS

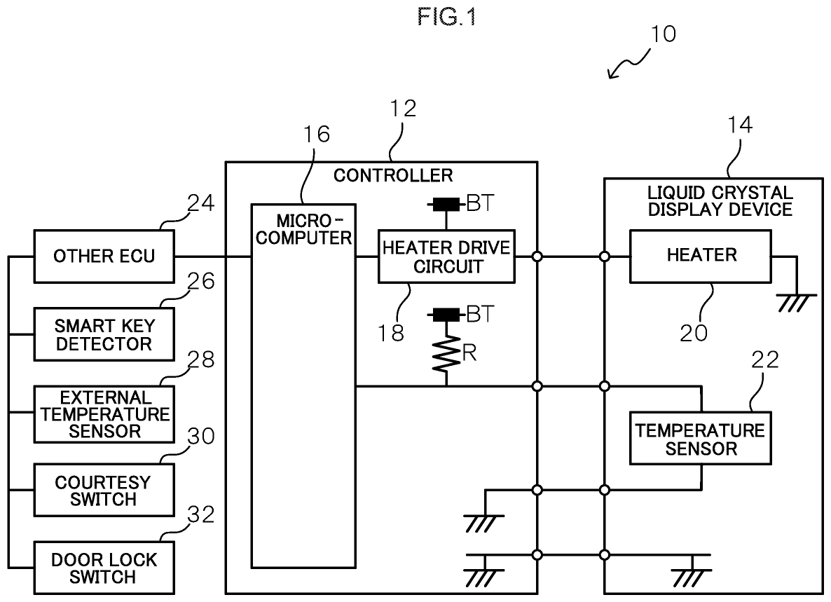

Detailed explanation follows regarding an exemplary embodiment of the present invention, with reference to the drawings. FIG. 1 is a block diagram schematically illustrating a configuration of a vehicle display device according to the exemplary embodiment.

As illustrated in FIG. 1, a vehicle display device 10 includes a controller 12 and a liquid crystal display device 14.

The liquid crystal display device 14 is provided with a heater 20 for mitigating a drop in the response speed of liquid crystals at low temperatures, and is also provided with a temperature sensor 22 that detects the temperature of the liquid crystal display device 14.

The heater 20 is driven by control of the controller 12 so as to heat the liquid crystal display device 14 when the temperature is low to mitigate a drop in the response speed of the liquid crystals when the temperature has dropped. One terminal of the heater 20 is grounded and another terminal of the heater 20 is connected to the controller 12. The controller 12 supplies the heater 20 with electric power from a battery BT to generate heat.

The temperature sensor 22 detects the temperature of the liquid crystal display device 14 and outputs information indicating the detected temperature to the controller 12 to determine whether or not to actuate the heater 20.

The liquid crystal display device 14 and the controller 12 each include grounding terminals, which are each connected so as to be grounded to the chassis ground of the automobile and the like.

The controller 12 is provided with a microcontroller 16 for controlling the liquid crystal display device 14, and is also provided with a heater drive circuit 18 for driving the heater 20.

The heater drive circuit 18, and the temperature sensor 22 provided to the liquid crystal display device 14, are connected to the microcontroller 16.

The temperature sensor 22 is connected to the battery BT through a pull-up resistor R, and a detection result from the temperature sensor 22 is input to the microcontroller 16.

The microcontroller 16 controls the heater drive circuit 18 based on the detection result from the temperature sensor 22 and so on, thereby controlling a supply of electric power from the battery BT to the heater 20.

The battery BT is connected to the heater drive circuit 18 as a power source for driving the heater 20. On receiving an activation instruction from the microcontroller 16, the heater drive circuit 18 supplies electric power from the battery BT to the heater 20 to drive the heater 20.

Another ECU 24 provided to the vehicle is also connected to the microcontroller 16. The microcontroller 16 is capable of acquiring various information through the other ECU 24. In the present exemplary embodiment, various information from a smart key detector 26, an external temperature sensor 28, a courtesy switch 30, and a door lock switch 32, all of which are connected to the other ECU 24, is input to the microcontroller 16 via the other ECU 24.

The smart key detector 26 detects whether or not a smart key in the possession of an operator is within a detection range. The external temperature sensor 28 detects the external temperature. The courtesy switch 30 is provided to a door opening of the vehicle, and detects opening and closing of the door. The door lock switch 32 detects unlocking and locking of a door lock. Note that in the present exemplary embodiment, the external temperature sensor 28 continually detects the external temperature so that the other ECU 24 can execute control based on the detection result.

In the present exemplary embodiment, at low temperatures at which the response speed of the liquid crystal display device 14 drops, the microcontroller 16 acquires the detection result from the smart key detector 26 via the other ECU 24 to detect the approach of the operator. The microcontroller 16 then controls the heater drive circuit 18 to drive the heater 20 for preheating prior to the operator boarding.

Note that in cases in which preheating is performed, although a preheating condition is satisfied by smart key detection, it is not certain that the operator intends to board the vehicle, and so there is a possibility that electric power used for the preheating is wasted due to the operator moving away from the vehicle after the smart key has been detected. Thus in the present exemplary embodiment, when the smart key is detected at temperatures at or below a predetermined temperature, a first electric power level, this being is lower than the rated electric power level for running the heater 20, is used to drive the heater 20 for preheating. For example, PWM control is used to drive the heater 20, and for the first electric power level, the heater 20 is driven with a duty ratio of 50%. This enables electric power that is wasted when the operator moves away from the vehicle after the smart key has been detected to be kept to a bare minimum.

In the present exemplary embodiment, the microcontroller 16 acquires information from the courtesy switch 30 and the door lock switch 32 via the other ECU 24 to detect when the operator is boarding. When the microcontroller 16 detects that the door has been opened or the door lock has been unlocked while the heater 20 is being driven at the first electric power level, in cases in which the temperature is at or below a predetermined temperature, output is increased from the first electric power level to a second electric power level to drive the heater 20. For example, in cases in which PWM control is used to drive the heater 20, the duty ratio is raised from 50%, for the first electric power level, to 80% to increase output and promote heating by the heater 20. Performing preheating in this manner by increasing the level of electric power driving the heater 20 in steps enables a drop in the response speed of the liquid crystal display device at low temperatures before the vehicle starts running to be mitigated while also saving electric power compared to cases in which preheating is performed at a single electric power level.

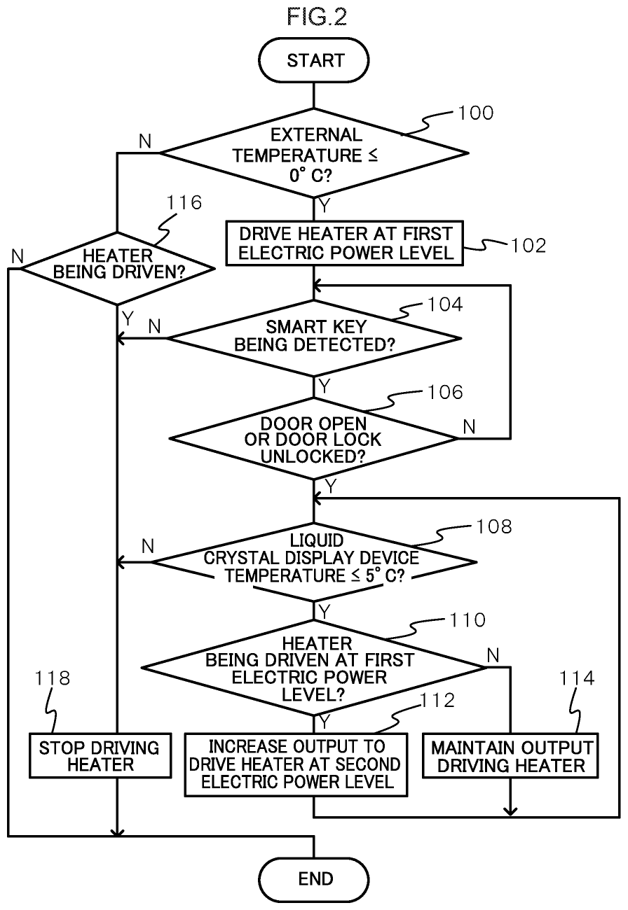

Explanation follows regarding specific processing implemented by the microcontroller 16 of the vehicle display device 10 according to the present exemplary embodiment configured as described above. FIG. 2 is a flowchart illustrating an example of a flow of processing implemented by the microcontroller 16 of the vehicle display device 10 according to the present exemplary embodiment. Note that the processing in FIG. 2 starts when a smart key in the possession of the operator has been detected by the smart key detector 26. The processing in FIG. 2 is, for example, implemented by executing a program pre-stored in the microcontroller 16.

When a smart key is detected by the smart key detector 26, at step 100, the microcontroller 16 determines whether or not the external temperature is at or below 0° C., this being the predetermined temperature range at which there is a possibility that the response speed of the liquid crystal display device 14 will drop. For this determination, the microcontroller 16 acquires information indicating the external temperature detected by the external temperature sensor 28 via the other ECU 24, and determines whether or not the external temperature is at or below 0° C., this being the temperature at which the response speed of the liquid crystal display device 14 drops. In cases in which determination is affirmative processing transitions to step 102, and in cases in which determination is negative processing transitions to step 116. Note that the reference temperature used to make the determination at step 100 is not limited to 0° C., and another value may be employed therefor.

At step 102, the microcontroller 16 controls the heater drive circuit 18 such that the heater 20 is driven at the first electric power level and processing transitions to step 104. As described above, the first electric power level is a lower electric power level than the rated electric power level of the heater 20, and, for example, an electric power level at which the heater 20 is driven with a duty ratio of 50%.

At step 104, the microcontroller 16 acquires the detection result from the smart key detector 26 via the other ECU 24, and determines whether or not the smart key is being detected. Namely, once the smart key has been detected, the microcontroller 16 determines whether or not this detection is continuous, without the operator moving away from the vehicle. In cases in which determination is affirmative processing transitions to step 106, and in cases in which determination is negative processing transitions to step 118.

At step 106, the microcontroller 16 acquires signals from the courtesy switch 30 and the door lock switch 32 via the other ECU 24, and determines whether or not the door has been opened or the door lock has been unlocked. Namely, at this step, determination is made as to whether or not the operator is boarding. In cases in which determination is negative processing returns to step 104 and the above-described processing is repeated. In cases in which determination is affirmative processing transitions to step 108.

At step 108, the microcontroller 16 determines whether or not the temperature is at or below 5° C., this being a temperature at which the response speed of the liquid crystal display device 14 drops, based on the information indicating the temperature detected by the temperature sensor 22. In cases in which determination is affirmative processing transitions to step 110, and in cases in which determination is negative processing transitions to step 118. Note that similarly to step 100, determination may be made based on information indicating the external temperature detected by the external temperature sensor 28. Moreover, the reference temperature used to make the determination at step 108 is not limited to 5° C., and another value may be employed therefor. Although in the present exemplary embodiment the determination reference temperatures are different at step 100 and step 108, the same temperature may be employed therefor.

At step 110, the microcontroller 16 determines whether or not the heater 20 is being driven at the first electric power level. In this determination, the microcontroller 16 determines whether or not the heater 20 is still being driven at the first electric power level rather than whether or not the heater 20 is being driven at the second electric power level implemented in step 112 described below. In cases in which determination is affirmative processing transitions to step 112, and in cases in which determination is negative processing transitions to step 114.

At step 112, the microcontroller 16 increases the output driving the heater 20 by controlling the heater drive circuit 18 such that the heater 20 is driven at the second electric power level, processing returns to step 108, and the above-described processing is repeated. As described above, the second electric power level is a greater electric power level than the first electric power level, and, for example, is an electric power level at which the heater 20 is driven with a duty ratio of 80%.

At step 114, the microcontroller 16 controls the heater drive circuit 18 so as to maintain the output driving the heater 20, processing returns to step 108, and the above-described processing is repeated.

At step 116, the microcontroller 16 determines whether or not the heater is being driven. Namely, the microcontroller 16 determines whether or not the smart key has been detected, step 102 has been executed, and the heater 20 is in a driven state. In cases in which determination is affirmative processing transitions to step 118, and in cases in which determination is negative processing ends without any further steps.

At step 118, the microcontroller 16 controls the heater drive circuit 18 to stop driving the heater 20, and the processing sequence ends.

Having the microcontroller 16 implement processing in this manner enables the liquid crystal display device 14 to be preheated at low temperatures such that a drop in the response speed of the liquid crystal can be mitigated prior to the operator boarding. Moreover, since two levels of electric power are used to perform preheating, electric power can be saved compared to cases in which preheating is performed at a single electric power level. This enables a drop in the response speed of the liquid crystal display device 14 at low temperatures before the vehicle starts running to be mitigated, while also saving electric power.

In the present exemplary embodiment, prior to starting preheating, the detection result from the external temperature sensor 28 employed by the other ECU 24 and the like is utilized at step 100 to detect the temperature without driving the temperature sensor 22, thereby enabling electric power that would be used to drive the temperature sensor 22 to be saved.

Preheating is stopped in cases in which the operator moves away without boarding after the smart key has been detected and preheating has been started, thereby enabling wasteful electric power consumption to be prevented.

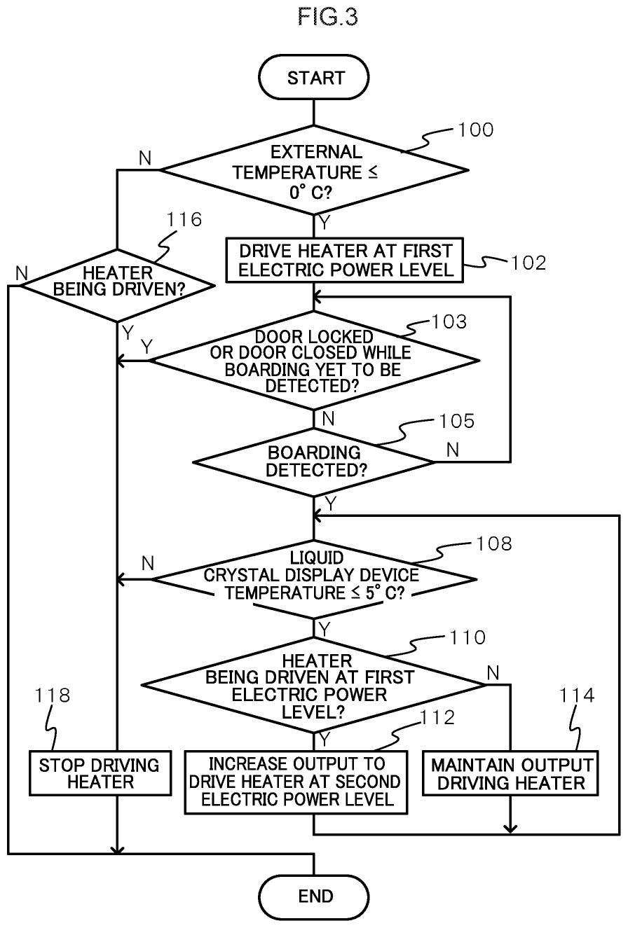

Explanation follows regarding a first modified example of processing implemented by the microcontroller 16 of the vehicle display device 10 according to the present exemplary embodiment. Basic configuration is the same as in the above exemplary embodiment, and so explanation thereof is omitted. FIG. 3 is a flowchart illustrating the first modified example of processing implemented by the microcontroller 16 of the vehicle display device 10 according to the present exemplary embodiment. Note that the same reference numerals are applied to processing that is the same as the processing in FIG. 2, and detailed explanation thereof is omitted.

In the above exemplary embodiment, preheating at the first electric power level starts when the smart key is detected, and preheating at the second electric power level starts when opening of the door or unlocking of the door lock is detected. However, in the first modified example, the preheating conditions at which preheating starts differ.

In the first modified example, preheating at the first electric power level starts when opening of the door or unlocking of the door lock is detected. Preheating at the second electric power level then starts when operator boarding is detected by a seating sensor provided to a vehicle seat, a buckle switch provided to a seatbelt buckle, or the like. Namely, although not illustrated in the drawings, configuration is such that information from the seating sensor or the buckle switch is acquired from the other ECU 24 by the microcontroller 16 to perform preheating.

As illustrated in FIG. 3, in the first modified example, steps 103 and 105 are performed instead of steps 104 and 106 in FIG. 2, and the processing in FIG. 3 is started in cases in which opening of the door or release of the door lock has been detected.

Namely, after the microcontroller 16 starts driving of the heater 20 at the first electric power level at step 102, processing transitions to step 103, and the microcontroller 16 determines whether or not door locking or door closing has been detected while boarding is still yet to be detected. In this determination, the microcontroller 16 determines that boarding is yet to be detected based on signals from the seating sensor or the buckle switch, and detects door locking or door closing based on signals from the door lock switch 32 and the courtesy switch 30. In cases in which determination is negative processing transitions to step 105, and in cases in which determination is affirmative processing transitions to the above-described step 118.

At step 105, the microcontroller 16 determines whether or not operator boarding has been detected. In this determination, the microcontroller 16 detects operator boarding based on signals from the seating sensor or the buckle switch. In cases in which the determination is affirmative processing transitions to the above-described step 108, and in cases in which determination is negative processing returns to step 103 and the above-described processing is repeated.

Advantageous effects similar to that of the above exemplary embodiment are able to be obtained when the microcontroller 16 implements processing in this manner.

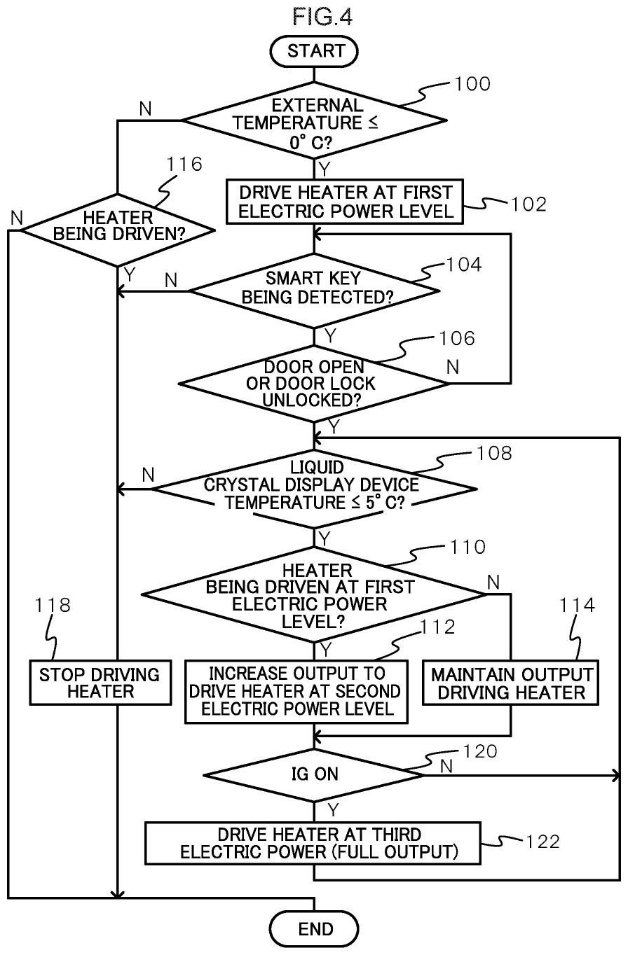

Explanation follows regarding a second modified example of processing implemented by the microcontroller 16 of the vehicle display device 10 according to the present exemplary embodiment. Basic configuration is the same as in the above exemplary embodiment, and so explanation thereof is omitted. FIG. 4 is a flowchart illustrating the second modified example of processing implemented by the microcontroller 16 of the vehicle display device 10 according to the present exemplary embodiment. Note that the same reference numerals are applied to processing that is the same as the processing in FIG. 2, and detailed explanation thereof is omitted.

In the above exemplary embodiment and the first modified example, examples were given in which two levels of electric power were used to drive the heater 20 for preheating. However, in the second modified example, three levels of electric power are used to drive the heater 20 for preheating. Note that although three levels of electric power are used to drive the heater 20 for preheating in the second modified example, configuration may be such that four or more levels are employed. For example, the preheating conditions in the above exemplary embodiment and the preheating conditions in the first modified example may be combined such that preheating is performed using four or more levels of electric power.

As illustrated in FIG. 4, in the second modified example steps 120 and 122 are added to the processing in FIG. 2.

Namely, processing transitions to step 120 after executing step 112 or step 114. At step 120, the microcontroller 16 determines whether or not an ignition switch (IG) has been switched on. In cases in which determination is affirmative processing transitions to step 122, and in cases in which determination is negative processing returns to step 108 and the above-described processing is repeated.

At step 122, the microcontroller 16 controls the heater drive circuit 18 to switch driving of the heater 20 to a third electric power level at full output (for example, with duty ratio of 100%), processing returns to step 108, and the above-described processing is repeated.

Thus using three levels of electric power perform preheating also enables a drop in the response speed of the liquid crystal display device 14 at low temperatures before the vehicle starts running to be mitigated, while saving electric power.

Note that in the above exemplary embodiment, determination is made at step 100 as to whether or not the external temperature is at or below 0° C., this being the temperature at which the response speed of the liquid crystal display device 14 drops, based on a detection result from the external temperature sensor 28 acquired from the other ECU 24. However, there is no limitation thereto. For example, determination may be made as to whether or not the temperature is a temperature at which the response speed of the liquid crystal display device 14 drops based on a detection result from the temperature sensor 22, although the electric power consumed by the liquid crystal display device 14 would increase accordingly. Alternatively, detection results may be acquired from both the temperature sensor 22 and the external temperature sensor 28 to determine whether or not the respective temperatures are at or below a predetermined temperature.

In the above exemplary embodiment, an example has been given in which the liquid crystal display device 14 serves as a display section. However, there is no limitation thereto. Namely, application may be made to other display devices provided that the response speed of the display device when displaying images drops at low temperatures.

An example has been given in which the processing implemented by the microcontroller 16 in the above exemplary embodiment is processing implemented by software. However, there is no limitation thereto. For example, the processing may be implemented by hardware, or may be implemented by a combination of both hardware and software.

The processing implemented by the microcontroller 16 in the above exemplary embodiment may also be stored, and distributed, as a program on a storage medium.

The present invention is not limited to the above description, and obviously various other modifications may be implemented within a range not departing from the spirit of the present invention.

The entire disclosure of Japanese Patent Application 2016-63933 filed Mar. 28, 2016 is incorporated by reference in the present specification.

1-7. (canceled)

8. A vehicle display device comprising:
a display section that displays an image;
an acquisition section that acquires information indicating at least one of a temperature of the display section or an external temperature;
a heater that heats the display section; and
a controller that controls driving of the heater such that the heater is driven at a predetermined first electric power level in cases in which information indicating a temperature at or below a predetermined temperature at which there is a possibility of a drop in a response speed of the display section is acquired by the acquisition section, and in which a predetermined preheating condition of the heater is satisfied, and such that the heater is driven at a second electric power level greater than the first electric power level in cases in which a predetermined drive condition of the heater is satisfied, wherein
the preheating condition is satisfied in cases in which a smart key has been detected by a detection section for detecting a smart key.

9. The vehicle display device of claim 8, wherein:
the drive condition is satisfied in cases in which information indicating a temperature at or below the predetermined temperature is acquired by the acquisition section, and boarding of an operator is detected by a boarding detection section for detecting operator boarding.

10. The vehicle display device of claim 8, wherein:
the controller further controls driving of the heater such that electric power supplied to the heater to drive the heater is switched to a third electric power level greater than the second electric power level in cases in which an automobile ignition switch has been switched on while the heater is being driven.

11. The vehicle display device of any one of claim 8, wherein:
the acquisition section acquires a detection result from an external temperature detection section that continually detects the external temperature as the information indicating the external temperature.

12. The vehicle display device of any one of claim 8, wherein:
the controller further controls driving of the heater such that driving of the heater is stopped in cases in which the preheating condition is no longer satisfied when the heater is being driven at the first electric power level.

13. The vehicle display device of any one of claim 8 wherein:
the controller further controls driving of the heater such that driving of the heater is stopped in cases in which a temperature higher than the predetermined temperature has been acquired by the acquisition section when the heater is being driven at the first electric power level.
